(19) United States
(12) Patent Application Publication
(10) Pub. No.: US 2002/0050017 A1
(43) Pub. Date: May 2, 2002

(54) Structure of windshield wiper

(76) Inventor: Tony Huang, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/802,888

(22) Filed: Mar. 12, 2001

(30) Foreign Application Priority Data
Nov. 2, 2000 (TW) 89219030

(51) Int. Cl. B60S 1/38

(52) U.S. Cl. 15/250.41; 15/250.48

(57) ABSTRACT

This invention is an improved structure of a windshield wiper. This structure has a long main body of wiper with a pressure plate inside. On both long sides of the main body, there are trenches which are used to fix the main body on the wiper. On one side of the trench, there is an indented trough. Finally, at the bottom of the main body, there are at least two main rubber blades.

### BACKGROUND OF THE INVENTION

This invention is about a windshield wiper, especially an improved structure of windshield wiper board.

Most commonly used windshield wipers only have one rubber blade with one main scraping plate. In real use, such kind of structure does not work very well. In order to upgrade wiper's ability to brush off water, people once came up with the idea listed in Attachment 1. Attachment 1 was a windshield wiper with double wiping boards. Although such new structure improved wiper's ability to brush off water, it still had some disadvantages.

1. Its structure was big and clumsy. As a result, when such a wiper is in use, it will cause a greater wind resistance, especially when the car is moving in a high speed. Under such a circumstance, resistance and turbulence are more obvious.

2. Most windshield holders on automobiles are designed to support one single wiper. If users to use this holder to support double wipers and its framework, this structure will result in a much heavier weight.

Moreover, it will affect the use and life span of wiper holder, causing damage to the car.

Therefore, such a product does not have good performance in real use. The purpose of this invention is to provide an improved structure of windshield wiper that can brush off water more efficiently and will not increase the total size of wiper.

In order to achieve the goal mentioned above, this invention provides an improved structure of windshield wiper. This structure has a long main body of wiper with a pressure plate inside. On both long sides of the main body, there are trenches which are used to fix the main body on the wiper. On one side of the trench, there is an indented trough. Finally, at the bottom of the main body, there are at least two main rubber blades.

### OUTLINING DIAGRAMS

The following is a real example with diagrams for further explanations:

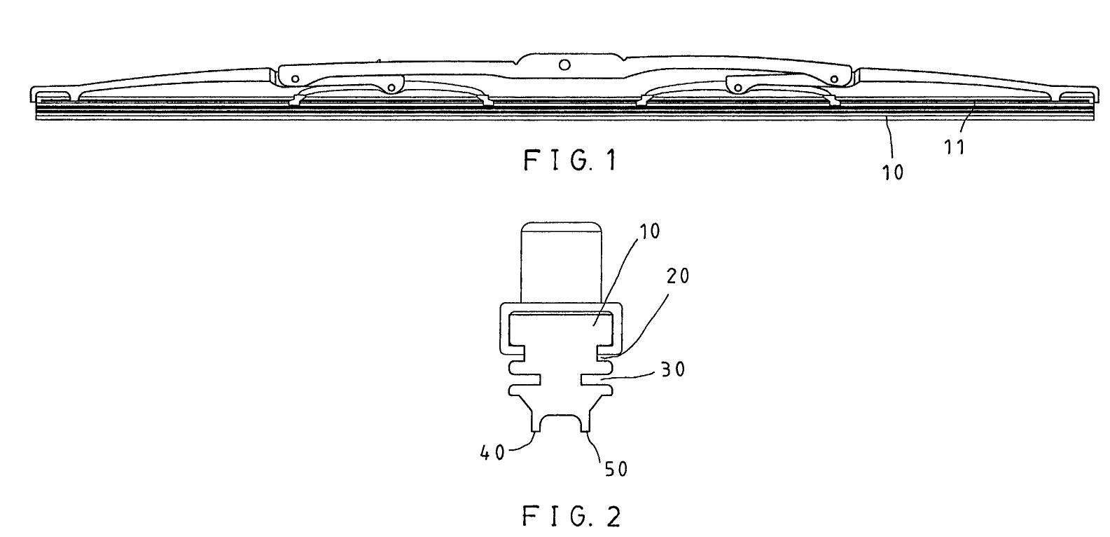

FIG. 1 is a diagram of this invention installed on a wiper.

FIG. 2 is a side view of this invention.

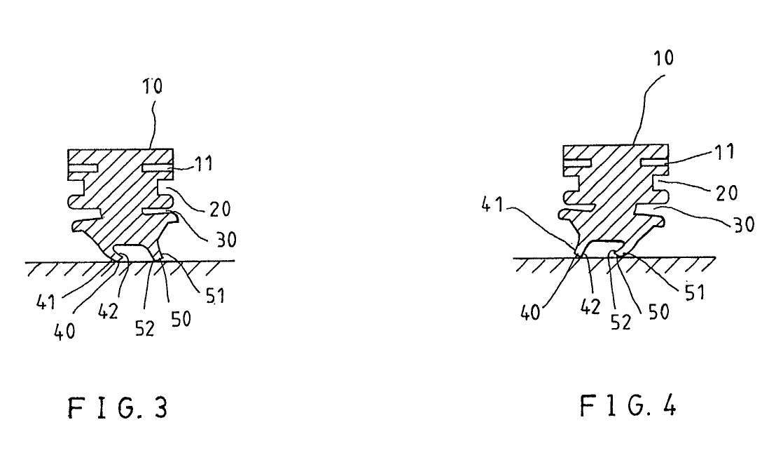

FIG. 3 and FIG. 4 are diagrams of this invention in use.

### DETAILED DESCRIPTIONS

Please refer to the figures. The wiper plate in this improved structure includes a main body (10) of the scraping plate. This part is made of material with great flexibility such as rubber or plastics. Its shape is long and can accommodate a pressure plate made of metal inside. In this real example of use, a pressure plate (11) is installed on both sides of the main body (10). Along the long axis of the main body and on both sides of the main body, there are two clipping trenches (20). These trenches are used for the main body to clip onto the framework of a wiper, the same as the traditional style. On one side of the trench, there is an indented trough (30) to increase the flexibility of the main body to bend to the left or the right. On the bottom of the main body, there are two protruding main rubber blades (40) and (50). The upper end of the main rubber blade is wider and the width decreases towards the protruding part.

Please refer to this invention with the above structure is in use as shown in FIG. 3 and FIG. 4. When the main body (10) moves from the right to the left as shown in the illustration, the invention can stay closely and tightly to the car window because the main body is made of material with high flexibility. This main rubber blade (40) can use its outer side (41) to scrape off most of the dust, grease or water on the car window. Then, the inner side (52) on the main rubber blade (50) can continue to scrape off the remaining water on the car window. Similarly, when the main body moves from the left to the right as shown in the illustration, the main rubber blade (50) can use its outer side (51) to scrape off most of the dust, grease or water on the car window. Then, the inner side (42) on the main rubber blade (40) can continue to scrape off the remaining water on the car window. Therefore, this structure enables two inner sides of two main rubber blades to be clean all the time and they will not lose the ability to scrape off dust or grease. In other words, this invention of improved windshield wiper has double scraping functions with excellent cleaning effect.

The advantages of this invention are:

1. It enables wipers to have double scraping functions.

Because this invention has two main rubber blades (40) and (50), it can provide double effects while scraping. Moreover, these two main rubber blades use their outer sides to scrape off dust and dirty particles and then use inner sides to completely remove water. As a result, such structure ensures and helps the inner sides of the main rubber blades not to lose their functions when removing dust or grease.

2. Light and small structure

This invention requires the same wiper holder as most wipers. When this invention is installed onto a wiper holder, it results in a much lighter and smaller weight than the old style of double rubber blades. Such a design also matches the design of wiper holders on automobiles better. The installation of such wiper will not cause any damage to cars and yet its scraping result is much better than the traditional ones. That is why this invention has a greater practicability.

The following is simple illustration of the figures:

FIG. 1 is a diagram of this invention installed on a wiper.

FIG. 2 is a side view of this invention.

FIG. 3 and FIG. 4 are diagrams of this invention in use.

1. An improved structure of wiper rubber blade made of material with great flexibility; this structure has a long main body, with at least two main rubber blades at its bottom; the two main rubber blades can bend flexibly during use to stay closely and tightly to the surface of scraping.

2. The same as the improved wiper rubber blade mentioned in claim 1, the side view of the two main rubber blades is like a toppled shape with wider top and narrower bottom.

3. The same as the improved wiper rubber blade mentioned in claim 1, there is at least one indented trough on each side of the long side of the main body.

4. The same as the improved wiper rubber blade mentioned in claim 1, on each of the long side of the main body, there is a clipping trench to enable the wiper boards to clip onto the wiper's framework.

5. The same as the improved wiper rubber blade mentioned in claim 1, on the main body, there is a pressure plate made of metal material.
